(19) United States
(12) Patent Application Publication
(10) Pub. No.: US 2025/0047123 A1
(43) Pub. Date: Feb. 6, 2025

(54) POWER MANAGEMENT SYSTEM AND POWER MANAGEMENT METHOD

(71) Applicant: MEDIATEK INC., Hsin-Chu (TW)

(72) Inventors: Yu-Tang Lin, Hsinchu City (TW); Shih-Hsum Cheng, Hsinchu City (TW)

(73) Assignee: MEDIATEK INC., Hsin-Chu (TW)

(21) Appl. No.: 18/760,011

(22) Filed: Jun. 30, 2024

Related U.S. Application Data
(60) Provisional application No. 63/517,623, filed on Aug. 4, 2023.

(51) Int. Cl. H02J 7/00

(52) U.S. Cl. CPC H02J 7/007182; H02J 2207/10; H02J 2310/22; H02J 2310/60

(57) ABSTRACT

A power management system, which is applied to an electronic device comprising a control circuit and a wireless communication device, is disclosed. The power management system comprises a first power management circuit, configured to provide first power to the control circuit; and a second power management circuit, configured to provide second power to the wireless communication device. The second power is controlled by the control circuit in a first mode of the electronic device. The second power is controlled by the second power management circuit and not controlled by the control circuit in a second mode of the electronic device. A power management method corresponding to the power management system is also disclosed.

### CROSS REFERENCE TO RELATED APPLICATIONS

This application claims the benefit of U.S. Provisional Application No. 63/517,623, filed on Aug. 4, 2023. The content of the application is incorporated herein by reference.

### BACKGROUND

The present application relates to a power management system and a power management method, and particularly relates to a power management system and a power management method which can extend the duration of location broadcasting.

In the event of electronic devices (e.g., a mobile phone) being lost or stolen, a function named as “BLE (Bluetooth Low Energy) Finding for Lost Device” can be activated. This function allows electronic devices to automatically transmit BLE broadcasts to inform their locations to paired electronic devices. An important requirement for this functionality is to remain operational in situations when the electronic device battery power is low or the electronic device is powered off. To meet such requirements, it is imperative that the electronic device is capable to continuously broadcast signals that would enable location finding.

Accordingly, a low power consumption broadcasting mechanism is needed, which is designed to extend the location broadcasting duration as long as possible, until the lost electronic device is found by the user. Furthermore, even when the electronic device is powered off, the BT (Bluetooth) Chip should have the capability to autonomously initiate broadcasting. Such function ensures the ongoing traceability of the electronic device under all power states.

### SUMMARY

One objective of the present application is to provide a power management system which can extend the duration of location broadcasting.

Another objective of the present application is to provide a power management method which can extend the duration of location broadcasting.

One embodiment of the present application discloses a power management system, applied to an electronic device comprising a control circuit and a wireless communication device, comprising: a first power management circuit, configured to provide first power to the control circuit; and a second power management circuit, configured to provide second power to the wireless communication device. The second power is controlled by the control circuit in a first mode of the electronic device. The second power is controlled by the second power management circuit and not controlled by the control circuit in a second mode of the electronic device.

Another embodiment of the present application discloses a power management method, applied to an electronic device comprising a control circuit, a first power management circuit, a second power management circuit, and a wireless communication device. The power management method comprises: providing first power to the control circuit by the first power management circuit; providing second power to the wireless communication device by the second power management circuit; controlling the second power in a first mode of the electronic device by the control circuit; and controlling the second power by the second power management circuit and not by the control circuit in a second mode of the electronic device.

In view of above-mentioned embodiments, the duration of location broadcasting can be extended, even if the battery power of the electronic device is low.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are block diagrams illustrating a power management system according to one embodiment of the present application.

FIG. 3 is a flow chart illustrating operations of the power management system in FIG. 1 and FIG. 2, according to one embodiment of the present application.

FIG. 4 is a wave chart illustrating signals of the power management system in FIG. 1 and FIG. 2, according to one embodiment of the present application.

FIG. 5 is a flow chart illustrating a power management method according to one embodiment of the present application.

FIG. 6 is a schematic diagram illustrating a practical application of the power management system, according to one embodiment of the present application.

### DETAILED DESCRIPTION

In the following descriptions, several embodiments are provided to explain the concept of the present application. It will be appreciated that the term “first”, “second”, “third” in following descriptions are only for the purpose of distinguishing different one elements, and do not mean the sequence of the elements. For example, a first device and a second device only mean these devices can have the same structure but are different devices.

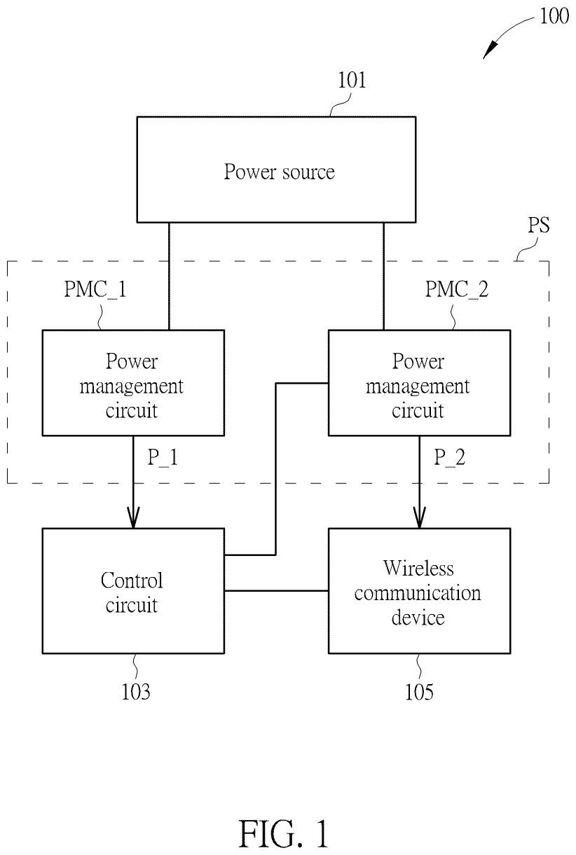

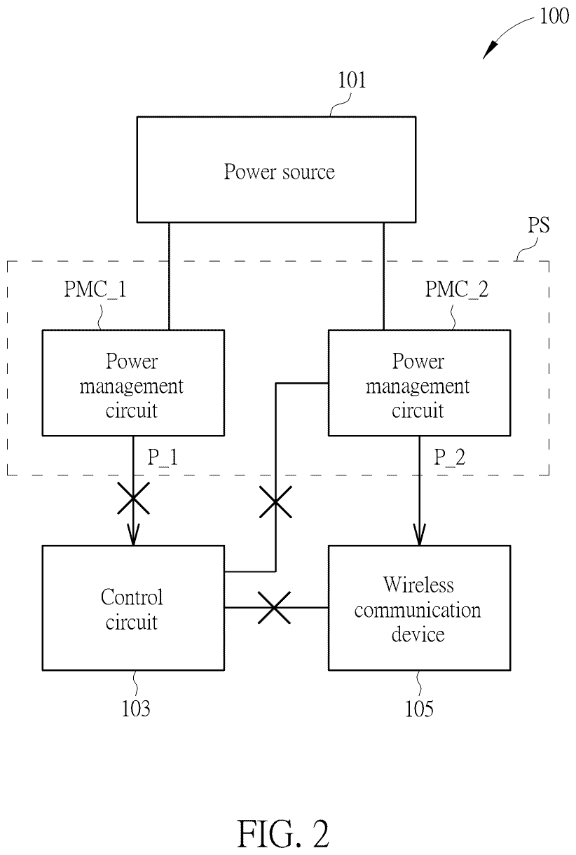

FIG. 1 and FIG. 2 are block diagrams illustrating a power management system according to one embodiment of the present application. The power management system PS, which comprises a first power management circuit PMC_1 and a second power management circuit PMC_2, is comprised in an electronic device 100. The electronic device 100 operates in a first mode in FIG. 1 and operates in a second mode in FIG. 2. As shown in FIG. 1, the electronic device 100 comprises a power source 101, a control circuit 103, a wireless communication device 105 and the power management system PS.

The first power management circuit PMC_1 is configured to provide first power P_1 to the control circuit 103. The second power management circuit PMC_2 is configured to provide second power P_2 to the wireless communication device 105. The control circuit 103 may control the first power management circuit PMC_1, the second power management circuit PMC_2 and the wireless communication device 105. Besides the first power management circuit PMC_1, the second power management circuit PMC_2 and the wireless communication device 105, the control circuit 103 may further control other devices of the electronic device 100. For example, the electronic device 100 is mobile device and control circuit 103 is a processing circuit provided in the mobile device. Such processing circuit may be used to control the display or power on, power off of the mobile device.

In following embodiments, the power source 101 is a battery. Also, the first power management circuit PMC_1, the second power management circuit PMC_2, the control circuit 103 are ICs, and the wireless communication device 105 is a Bluetooth device. However, it does not mean to limit the scope of the present invention. As above-mentioned, the electronic device 100 operates in a first mode in FIG. 1. Also, in the first mode, the second power is controlled by the control circuit 103. In one embodiment, the first mode means a normal mode of the electronic device 100. The operation clock signals of the wireless communication device 105 may also be provided or controlled by the control circuit 103. The speed or timings of operations, such as transmitting or receiving signal, of the wireless communication device 105 may be determined by the operations clock signals.

Accordingly, in one embodiment, a user starts by powering on the electronic device 100, thus the control circuit 103 is boot up through the first power P_1 provided by the first power management circuit PMC_1. By this way, the electronic device 100 operates in the normal mode. In the normal mode, the wireless communication device 105 may be turned on (activated) by activating the device's Bluetooth functionality. In one embodiment, the control circuit 103 maintains the enable pin on the second power management circuit PMC_2, allowing it to remain active. The second power management circuit PMC_2 then supplies power to the wireless communication device 105, facilitating its operation.

In the second mode of the electronic device 100, the second power P_2 is controlled by the second power management circuit PMC_2 and not controlled by the control circuit 103, as shown in FIG. 2. Further, in the second mode, an operation clock signal of the wireless communication device 105 may be controlled by the second power management circuit PMC_2 and not controlled by the control circuit 103. Accordingly, the second power management circuit PMC_2 may also be regarded as a wireless communication control circuit.

The trigger of the second mode may be different in different embodiments. In one embodiment, the electronic device 100 operates in the first mode when a battery power of the electronic device 100 is higher than a first power threshold and operates in the second mode when the battery power is lower than a second power threshold, wherein the second power threshold is lower than or equal to the first power threshold. In other words, the electronic device 100 operates in the first mode if the battery power is high and operates in the second mode if the battery power is low.

In another embodiment, at least one device of the electronic device 100 is turned off (non-active) in the second mode. For example, the display of the electronic device 100 is turned off in the second mode. In another embodiment, no other devices besides the second power management circuit PMC_2 and the wireless communication device is active in the second mode. In other words, the second mode is a power off mode, the electronic device 100 is powered off and the control circuit 103 is non-active, but the second power management circuit PMC_2 and the wireless communication device are still active. Accordingly, as shown in FIG. 2, the first power management circuit PMC_1 does not provide the first power P_1 to the control circuit 103 in the second mode.

In the second mode, the wireless communication device 105 still can work since the power management circuit PMC_2 still provides the second power P_2, thus the wireless communication device 105 broadcasts a location of the electronic device 100 in the second mode. The broadcasted location may be received by another paired electronic device, thus the electronic device 100 may be found by the user according to the broadcasted location. The steps or contents of location broadcasting may be different corresponding to the communication standard used by the wireless communication device 105. Please note, in one embodiment, the wireless communication device 105 also broadcasts location in the first mode.

As above-mentioned, the wireless communication device 105 may broadcast location in the power saving mode or the power off mode of the electronic device 100. Accordingly, the user may try to turn on the electronic device 100 after the electronic device 100 has been found according to the broadcasted location. In such case, the electronic device 100 switches from the second mode to the first mode if the power button is triggered.

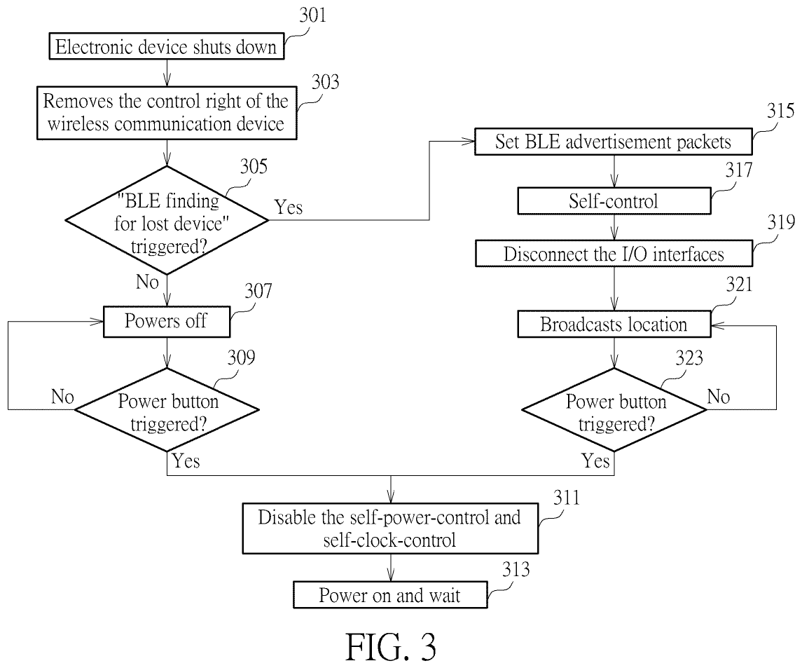

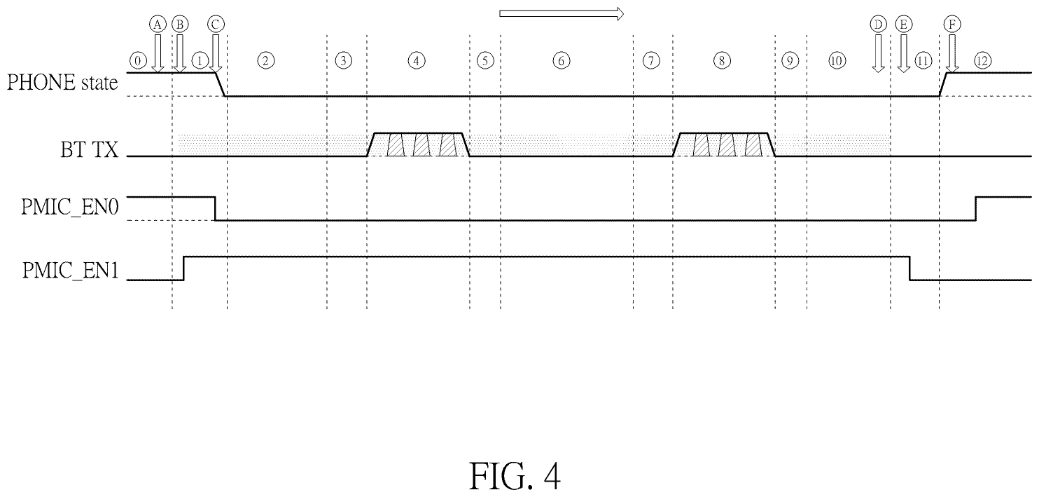

FIG. 3 is a flow chart illustrating operations of the power management system in FIG. 1 and FIG. 2, according to one embodiment of the present application. FIG. 4 is a wave chart illustrating signals of the power management system in FIG. 1 and FIG. 2, according to one embodiment of the present application. More detail operations of the power management system are illustrated in FIG. 3 and FIG. 4. Please note, FIG. 3 and FIG. 4 are only examples for explaining, and do not mean to limit the scope of the present invention.

FIG. 3 comprises following steps:

### Step 301

The electronic device 100 shut down.

For example, the battery power of the electronic device 100 is low or 0, such that the electronic device 100 enters a power saving mode or a power off mode.

### Step 303

Removes the control right of the wireless communication device 105 from the control circuit 103.

For example, remove the registration of the BT driver of the wireless communication device 105 from the control circuit 103. By this way, the control circuit 103 could not control the second power P_2 in the second mode.

The BT driver may be implemented by at least one program stored in a storage device which the wireless communication device 105 can read. In one embodiment, the storage device and the wireless communication device 105 are provided in a single chip, such as a BT chip.

### Step 305

Is the function of “BLE finding for lost device” triggered or not? If not, go to step 307. If yes, go to step 309.

Such trigger may be pre-set by the user.

### Step 307

The electronic device 100 powers off.

### Step 309

Determine if the power button is triggered or not. If not, stay in the step 307. If yes, go to step 311.

### Step 311

Disable the self-power-control and self-clock-control of the second power management circuit PMC_2.

As above-mentioned, the second power management circuit PMC_2 may be used to control the second power P_2 and/or the operation clock of the wireless communication device 105.

### Step 313

The electronic device 100 powers on and waits for the control circuit 103 to power on the second power management circuit PMC_2.

Steps 311 and 313 can be regarded as the step of “switching from the second mode to the first mode”.

### Step 315

Set BLE advertisement packets. Such setting may be performed by the electronic device 100 itself before broadcasting the location, but also can be preset by the user.

The step 315 further comprises a step of “BT driver sending a start command to the second power management circuit PMC_2”. The start command means starting the self-power-control and self-clock-control of the second power management circuit PMC_2.

### Step 317

The second power management circuit PMC_2 controls the second power P_2 and the operation clock signals of the wireless communication device 105 by itself.

### Step 319

Disconnect the control right of the I/O interfaces of the electronic device 100 from the control circuit 103.

In one embodiment, the I/O interfaces do not comprise the power button.

### Step 321

The wireless communication device 105 broadcasts the location of the electronic device 100.

### Step 323

Determine if the power button is triggered or not. If not, go stay in the step 321. If yes, go to step 311.

In the embodiment of FIG. 4, the second mode means the electronic device 100 is powered off. For example, the electronic device 100 is lost and the battery power thereof is too low thus the electronic device 100 automatically powers off. Also, the first mode in FIG. 4 is the normal mode. Please note, for the convenience of explaining, only the signals related with the operations in FIG. 3 are illustrated in FIG. 4.

In the embodiment of FIG. 4, the signal PHONE state means the state of the electronic device 100, the signal BT_TX means the signals generated by the wireless communication device 105, and signals PMIC_EN0, PMIC_EN1 correspond to the mode of the second power management circuit PMC_2. Further, english alphabets A, B, C . . . mean events and numbers 0, 1, 2, 3 . . . means periods. In period 0, the electronic device 100 operates in the normal mode, and the power off process starts in period 1. The event A means the control circuit 103 turns off and event B means the second power management circuit PMC_2 is disconnected from the control circuit 103. Also, event C means the control circuit 103 turns off. Accordingly, in period 1, the signal PHONE state transits from high to low, and the dotted region of the signal BT_TX means the wireless communication device 105 is ready to broadcast location. Further, in period 1, the signal PMIC_EN0 transits from high to low, which means the second power management circuit PMC_2 is leaving a mode in which the second power management circuit PMC_2 is controlled by the control circuit 103. Additionally, in period 1, the signal PMIC_EN1 transits from low to high, which means the second power management circuit PMC_2 is entering a mode in which the second power management circuit PMC_2 controls the second power P_2 and the operation clock signal by itself.

Period 2 means waiting for N seconds (e.g., 2 seconds) before the 1^{st} BLE advertisement. Period 3 means the wireless communication device 105 enters active. Period 4 means the 1^{st} BLE advertisement (the trapezoid). Period 5 means the wireless communication device 105 enters UDS (Ultra-Deep-Sleep). Period 6 means the wireless communication device 105 sleeps for M seconds (e.g., 2 seconds). Periods 5 and 6 may save the battery power of the electronic device 100. Periods 7, 8, 9, 10 repeat the operations of periods 3, 4, 5, 6. The event D in period 10 means the power button is triggered to turn on the electronic device 100.

In period 11, the control circuit 103 is reset, thus event E means the control circuit 103 is reset. Further, in period 11, the second power management PNC_2 is reset and leaves the mode in which the second power management circuit PMC_2 controls the second power P_2 and the operation clock signal by itself. Accordingly, in period 11, the signal PMIC_EN1 transits from high to low. In period 12, the signal PMIC_EN0 transits from low to high and the electronic device 100 powers on, thus the event F means the control circuit 103 turns on.

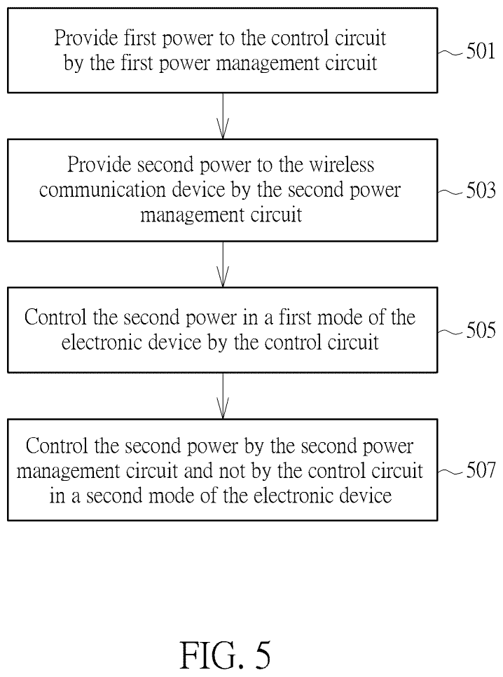

In view of above-mentioned embodiments, a power management method shown in FIG. 5 may be acquired. The power management method is applied to an electronic device comprising a control circuit, a first power management circuit, a second power management circuit, and a wireless communication device, such as the electronic device shown in FIG. 1 and FIG. 2. The power management method shown in FIG. 5 comprises:

### Step 501

Provide first power P_1 to the control circuit by the first power management circuit.

### Step 503

Provide second power P_2 to the wireless communication device by the second power management circuit.

### Step 505

Control the second power P_2 in a first mode of the electronic device by the control circuit.

### Step 507

Control the second power P_2 by the second power management circuit and not by the control circuit in a second mode of the electronic device.

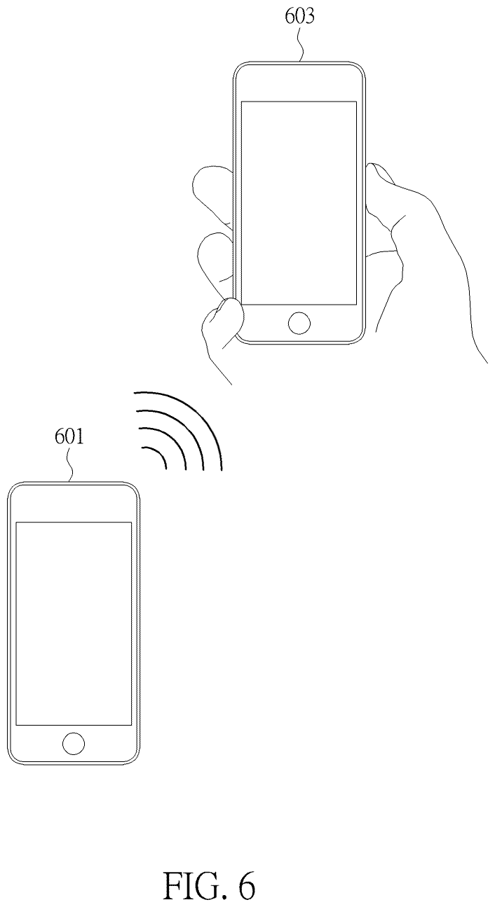

FIG. 6 is a schematic diagram illustrating a practical application of the power management system, according to one embodiment of the present application. It will be appreciated that the scope of the present application is not limited to such application. In FIG. 6, a mobile phone 601 has a function of “BLE (Bluetooth Low Energy) Finding for Lost Device” but is lost. Within a short period of time after the loss, the mobile phone 601 still have power thus may operate in the first mode. In such mode, the mobile phone 601 may broadcast location or does not broadcast location. Also, in such mode, the power of the wireless communication device of the mobile phone 601 is controlled by a control circuit thereof.

After the mobile phone 601 is lost for a long time, the battery power of the mobile phone 601 may become low thus the mobile phone 601 enters the second mode, which may be the power saving mode or the power off mode. In the second mode, the mobile phone 601 broadcasts location, and the power of the wireless communication device of the mobile phone 601 is controlled by the second power management circuit but not controlled by the control circuit. By this way, the user may use another mobile phone 603 which can receive the broadcasted location to find the mobile phone 601. Please note, the details of the first mode and the second mode may be changed corresponding to different requirements.

In view of above-mentioned embodiments, the duration of location broadcasting can be extended, even if the battery power of the electronic device is very low or the electronic device is powered off.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management system, applied to an electronic device comprising a control circuit and a wireless communication device, comprising:
a first power management circuit, configured to provide first power to the control circuit; and
a second power management circuit, configured to provide second power to the wireless communication device;
wherein the second power is controlled by the control circuit in a first mode of the electronic device;
wherein the second power is controlled by the second power management circuit and not controlled by the control circuit in a second mode of the electronic device.

2. The power management system of claim 1, wherein the wireless communication device broadcasts a location of the electronic device in the second mode.

3. The power management system of claim 2, wherein the wireless communication device is a Bluetooth device.

4. The power management system of claim 3, wherein the electronic device is a mobile device.

5. The power management system of claim 1, wherein the electronic device operates in the first mode when a battery power of the electronic device is higher than a first power threshold and operates in the second mode when the battery power is lower than a second power threshold, wherein the second power threshold is lower than or equal to the first power threshold.

6. The power management system of claim 1, wherein at least one device of the electronic device is non-active in the second mode.

7. The power management system of claim 6, wherein no other devices besides the second power management circuit and the wireless communication device is active in the second mode.

8. The power management system of claim 6, wherein the electronic device comprises a power button, wherein the electronic device switches from the second mode to the first mode if the power button is triggered.

9. The power management system of claim 1, an operation clock signal of the wireless communication device is controlled by the second power management circuit and not controlled by the control circuit in the second mode.

10. A power management method, applied to an electronic device comprising a control circuit, a first power management circuit, a second power management circuit, and a wireless communication device, comprising:
providing first power to the control circuit by the first power management circuit;
providing second power to the wireless communication device by the second power management circuit;
controlling the second power in a first mode of the electronic device by the control circuit; and
controlling the second power by the second power management circuit and not by the control circuit in a second mode of the electronic device.

11. The power management method of claim 10, further comprising:
broadcasting a location of the electronic device by the wireless communication device in the second mode.

12. The power management method of claim 11, wherein the wireless communication device is a Bluetooth device.

13. The power management method of claim 12, wherein the electronic device is a mobile device.

14. The power management method of claim 10, wherein the electronic device operates in the first mode when a battery power of the electronic device is higher than a first power threshold and operates in the second mode when the battery power is lower than a second power threshold, wherein the second power threshold is lower than or equal to the first power threshold.

15. The power management method of claim 10, wherein at least one device of the electronic device is non-active in the second mode.

16. The power management method of claim 15, wherein no other devices besides the second power management circuit and the wireless communication device is active in the second mode.

17. The power management method of claim 15, wherein the electronic device comprises a power button, wherein the power management method further comprises:
switching the electronic device from the second mode to the first mode if the power button is triggered.

18. The power management method of claim 10, further comprising:
controlling an operation clock signal of the wireless communication device by the second power management circuit and not by the control circuit in the second mode.
